(19) United States
(12) Patent Application Publication
(10) Pub. No.: US 2010/0062673 A1
(43) Pub. Date: Mar. 11, 2010

(54) Method For Integral Recycling For Cathode Ray Tubes

(75) Inventors: Farouk Tedjar, Grenoble (FR); Jean-Claude Foudraz, Fontaine (FR); Isabelle Desmuee, Les Adrets (FR); Christelle Pasquier, Saint Hilaire du Touvet (FR); Saverio Martorana, Domene (FR)

Correspondence Address: OLIFF & BERRIDGE, PLC, P.O. BOX 320850, ALEXANDRIA, VA, 22320-4850, US

(73) Assignees: RECUPYL, Domene (FR); TECHNI SERVICES ENVIRONNEMENT, Domene (FR)

(21) Appl. No.: 11/988,052

(22) PCT Filed: Jul. 4, 2005
(86) PCT No.: PCT/FR2005/001711

§ 371 Date: Dec. 28, 2007

(51) Int. Cl. H01J 9/50

(52) U.S. Cl. 445/2

(57) ABSTRACT

The present invention relates to a method for integral recycling of cathode ray tubes characterized in that it enables glasses which compose said cathode ray tubes and luminophores deposited on an internal surface of screens to be recycled by associating the following steps: opening said cathode ray tubes by means of a laser source; dry cleaning by means of surface treatment agents; and recycling the luminophores by acid-base means in the presence of fluorides. Well-chosen association of a particular opening method, of a dry surface treatment and a hydrometallurgical treatment step of the luminophores powders results in a method enabling both protection of environment and of a workstation and a high material valorization rate.

### BACKGROUND OF THE INVENTION

The invention relates to a method for integral recycling of cathode ray tubes.

### STATE OF THE ART

Electrical and electronic equipment production is a greatly expanding field in the Western world.

Technological innovation and market expansion are continuing to speed up the replacement process of products having a lifetime which does not exceed 3 years. Thus, in 2000, the production of end-of-life electrical and electronic waste in France was evaluated at 1.5 million tonnes, half of which being household waste. Since then, a progression of 3 to 5% per year of this figure has been observed. European deposits of these waste products are estimated at 400,000 T/year, 90% of which still end up in landfills. This is why new directives stringently regulate this type of waste, the latest to date being directive 2002/96/CE of 27 Jan. 2003.

These new rules for management of such products impose minimum recycling rates. Cathode ray tubes do however represent a relatively large proportion of end-of-life electrical appliances and electronic equipment. Therefore, to achieve the required global recycling rate, it is imperative to achieve high recycling rates for cathode ray tubes.

A colour cathode ray tube comprises a faceplate glass containing among others barium and strontium oxides, and a cone glass containing a large quantity of lead oxide. These two parts are joined to one another by a seal and are coated with layers called “functional layers” formed by metal oxides, rare earths, graphite and iron. Metal parts in the form of plates are placed inside the tubes before the latter are closed. In particular the layer deposited on the inside surface of the faceplates is composed of Zinc, Cadmium, Yttrium and Europium-based electroluminescent materials. All these compounds tend to give the cathode ray tube as a whole a toxic nature, which is why various solutions have been proposed for treatment of these cathode ray tubes.

U.S. Pat. No. 4,858,833 describes a cathode ray tube recycling method by crushing, then treatment with fluoroboric acid followed by selective separation of the various components. This method presents several drawbacks, in particular on account of mixing of the glasses, dissolution of metal parts and the use of fluoroboric acid. In particular, this acid has shown its limits in waste treatment in particular through all the attempts to perform industrialization of the processes (in particular in battery recycling). The glasses obtained by mixing the faceplate (barium-based) and the cone (lead-based) are difficult to recycle as-is.

It has therefore proved indispensable to proceed with opening of the tubes and to separate the tubes. The first method used is the diamond slitting wheel. This technique ensures good opening, but is accompanied by large emissions of glass particles and requires manual operations.

It is to overcome this drawback that Patent DE4234706 describes a method for opening and separating the two components by means of a heating wire. This separation can only be performed if notches are made over the whole perimeter of the cathode ray tube, and the rate at which this type of operation can be performed limits the productivity and requires very precise placing of the wire after the notches have been made.

Moreover, the luminophore layer composed of electroluminescent materials is at present removed by any physical means and the powders obtained are sent to a toxic waste storage centre.

No operational industrial process providing an outlet for these powders has as yet been established.

In general manner, methods using oxalate for separation of rare earths have been known for a very long time, as they have already been proposed since the early 1900's and have been extensively implemented (C. James, J. Am. Chem. Soc. vol. 30, p. 979, 1908). They are efficient for mixtures of lanthanum, thorium, yttrium and cerium. The full processes are moreover extensively described in the reviews Journal of Soc. Chem. Eng, (R. W Urie, 46(437) year 1947 and E. S Pilkington 46(387) year 1947) and J. Appl. Chem. [E. S Pilkington 2(265) year 1952 and 4(568) year 1954]. The presence of zinc, cadmium and yttrium on the other hand singularly complicates operations. In addition, the precipitate, which is very fine, gives rise to impurities (in particular the etching acid anions). Finally, formation of oxalate complexes with the other products results in over-consumption of oxalate.

It is for this reason that various different methods have been proposed. We have already seen that U.S. Pat. No. 4,858,833 describes a process for recycling these powders via a fluoroboric method followed by precipitation of oxalates. In addition to the drawbacks of fluoroboric acid, the oxalates have to be calcinated to obtain recyclable oxides, which leads to emission of CO₂.

Patent DE19918793 describes a process for recycling these powders by etching with nitric acid followed by carbonate precipitation and then calcination to obtain oxides. There again, the drawbacks are mainly related to emissions of nitrogen oxide and CO₂.

### OBJECT OF THE INVENTION

The object of the invention is to provide a method for integral recycling of cathode ray tubes enabling these different drawbacks to be overcome.

According to the invention, this object is achieved by the appended claims.

More particularly, this object is achieved by the fact that the method enables the glasses composing said cathode ray tubes and the luminophores deposited on the internal surface of screens to be recycled by associating the following steps:
opening said cathode ray tubes by means of a laser source
dry cleaning by means of surface treatment agents
and recycling of the luminophores by acid-base means in the presence of fluorides.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 schematically represents the main steps of the recycling method according to the invention.

FIGS. 2 and 3 respectively represent observation with an electron microscope and X-ray diffraction analysis of a cone glass dry treated by a cleaning agent in solid state.

FIG. 4 represents an observation with an electron microscope of a faceplate glass dry treated by a cleaning agent in solid state.

FIGS. 5 and 6 respectively represent observation with a scanning electron microscope and X-ray diffraction analysis of the fraction larger than 500 microns obtained by means of a screening operation performed during the luminophore recycling step.

FIGS. 7 and 8 respectively represent observation with a scanning electron microscope and X-ray diffraction analysis of first particles extracted from the fine fraction (less than 500 microns) obtained when a screening operation is performed during the luminophore recycling step.

FIGS. 9 and 10 respectively represent observation with a scanning electron microscope and X-ray diffraction analysis of second particles extracted from the fine fraction (less than 500 microns) obtained when a screening operation is performed during the luminophore recycling step.

FIG. 11 schematically represents the different steps of a chemical process implemented in the luminophore recycling step.

### DESCRIPTION OF PARTICULAR EMBODIMENTS

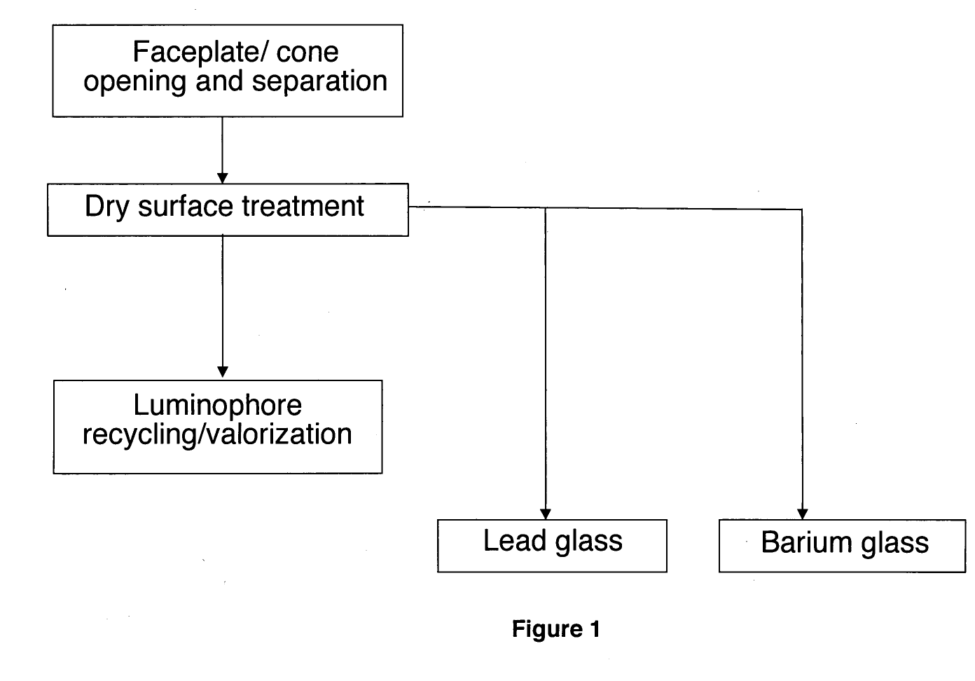

As illustrated in FIG. 1, the method for integral recycling of cathode ray tubes according to the invention consists in associating an opening operation of the cathode ray tubes, a surface treatment for the glasses and a recycling process of luminophores.

### I—Opening the Cathode Ray Tubes

The cathode ray tubes are opened by means of a laser source, such as a CO₂ laser with a power comprised between 300 mW and 3 kW and a wavelength comprised between 10 μM and 11 μm.

A first advantage of this opening method lies in the fact that opening does not require an initial notch. This is advantageous as the notches have the consequence of considerably reducing the opening time. A second advantage stems from the fact that the power of the laser is sufficient to destroy the seal completely, which provides a direct opening at the junction between the faceplate and the cone, whereas opening by saw or by heating wire leaves about a centimeter of the faceplate glass joined to the body of the cone.

Once the cathode ray tubes have been opened, for a good valorization of the glasses it is important that all the coating products situated on the internal surface of the faceplate and on the internal and external surfaces of the cones be totally eliminated.

In order to provide protection of the workstation operators and to achieve an efficient surface treatment, techniques such as direct dry brushing are discarded. With a concern for protection of the environment and to avoid eliminating large quantities of waste water, washing with water is discarded.

### II—Glass Surface Cleaning

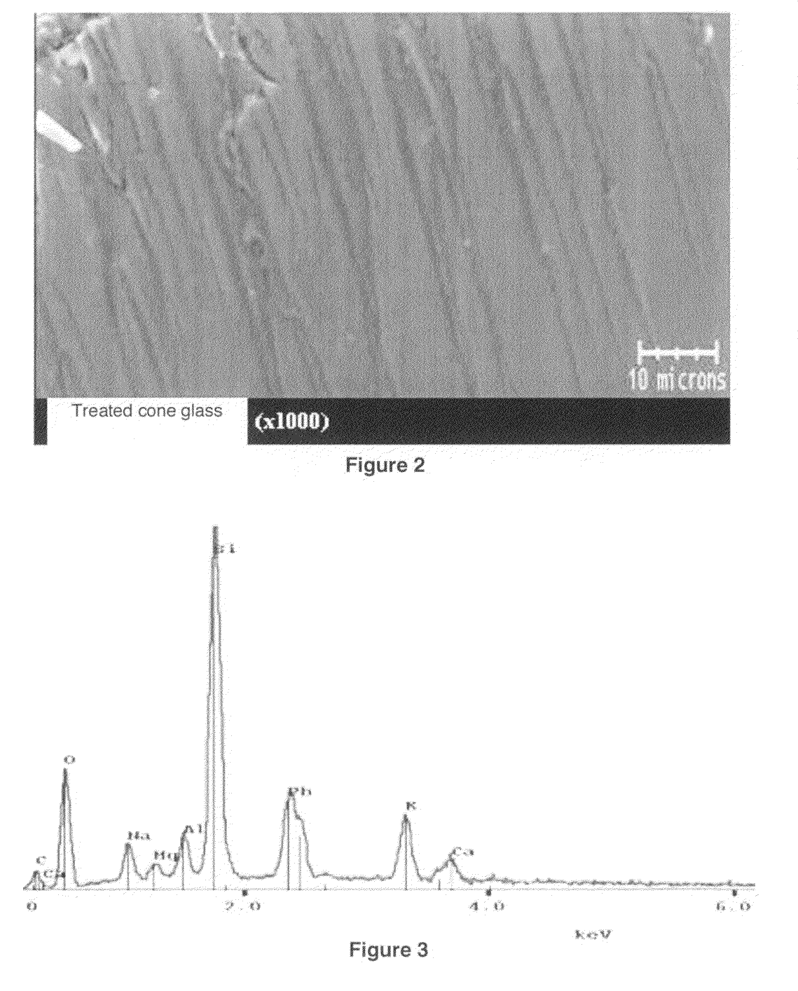

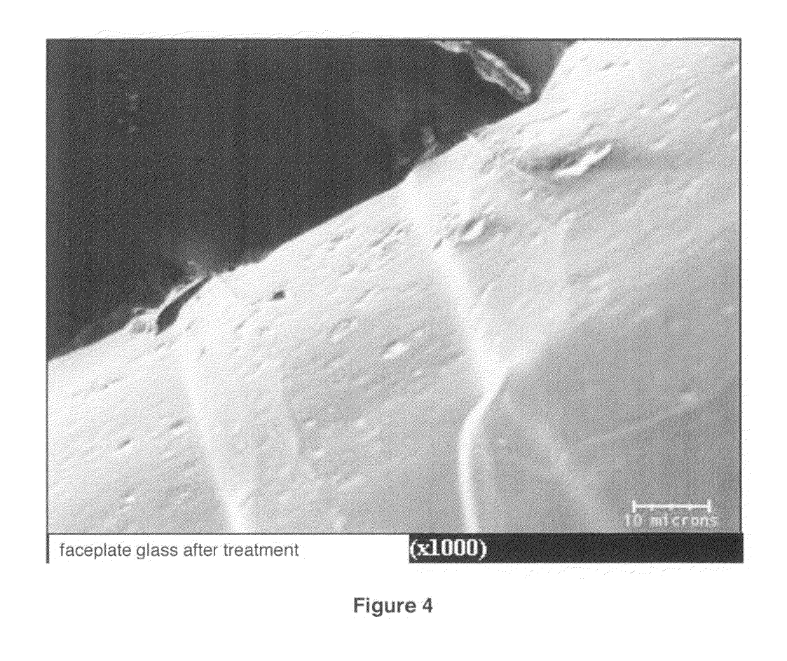

The surface oxides are thus removed by dry treatment by means of a surface treatment agent (cleaning agent) in solid state. The agents used are preferably chosen from steel shot, sodium bicarbonate and calcite. These three products have in fact given satisfactory results in so far as the layers are totally eliminated, in particular on the layers where they are very adherent, as illustrated in FIGS. 2 and 3 and in FIG. 4 (images after treatment).

These three products are preferably chosen for the ease of subsequent treatment of the mixed fractions comprising the surface treatment agent and the products resulting from the surface treatment.

When steel shot is used for treating the faceplate and the cone, the products obtained are treated by magnetic separation to separately obtain the luminophores or other oxides on the one hand and the steel shot on the other hand.

When sodium bicarbonate or calcite is used for treating the faceplate, these products are eliminated during treatment of the luminophores.

### III—Luminophores Recycling

The luminophores powders are treated by a method that does not involve either oxalate or ammonia. The electroluminescent assembly comprises an aluminium sheet and a layer of luminophores powders. A very large majority of the powders are able to be separated by screening at 500 microns.

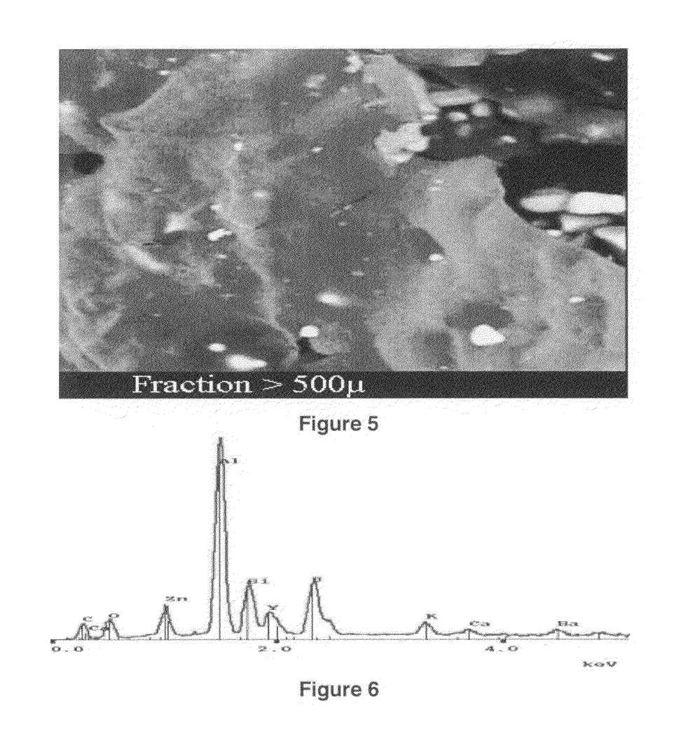

The fraction larger than 500 microns is mainly composed of aluminium foil as shown by FIGS. 5 (photograph taken with a scanning electron microscope) and 6 (X-ray diffraction analysis).

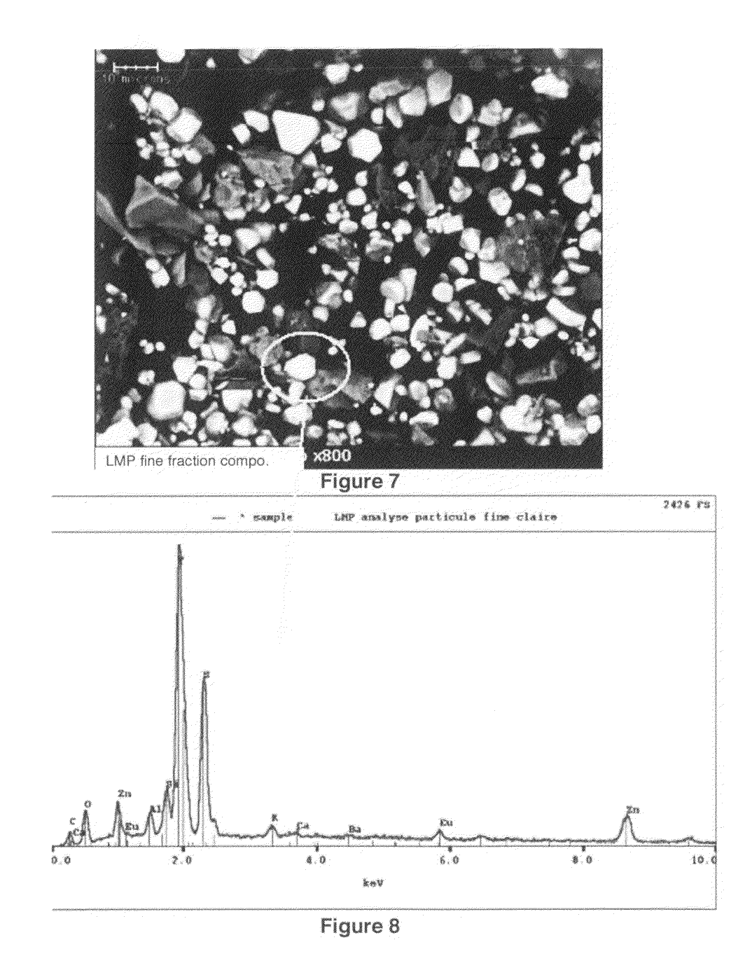

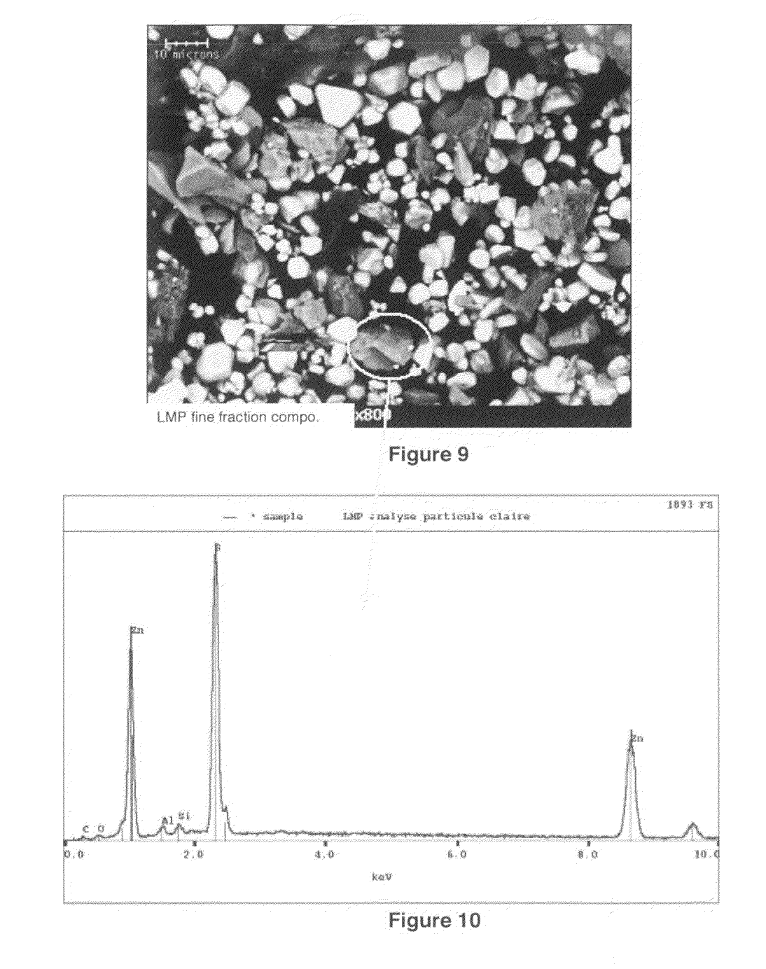

The fine fraction is mainly composed of zinc and yttrium with the presence of europium, iron and manganese, as shown by scanning electron microscope observation (FIGS. 7 and 9) associated with X-ray diffraction microanalysis (FIGS. 8 and 10). For the phase distribution, the zinc is engaged in sulphide form whereas the yttrium and the europium are present in oxide and oxysulphide form, as we have shown by X-ray diffraction analysis.

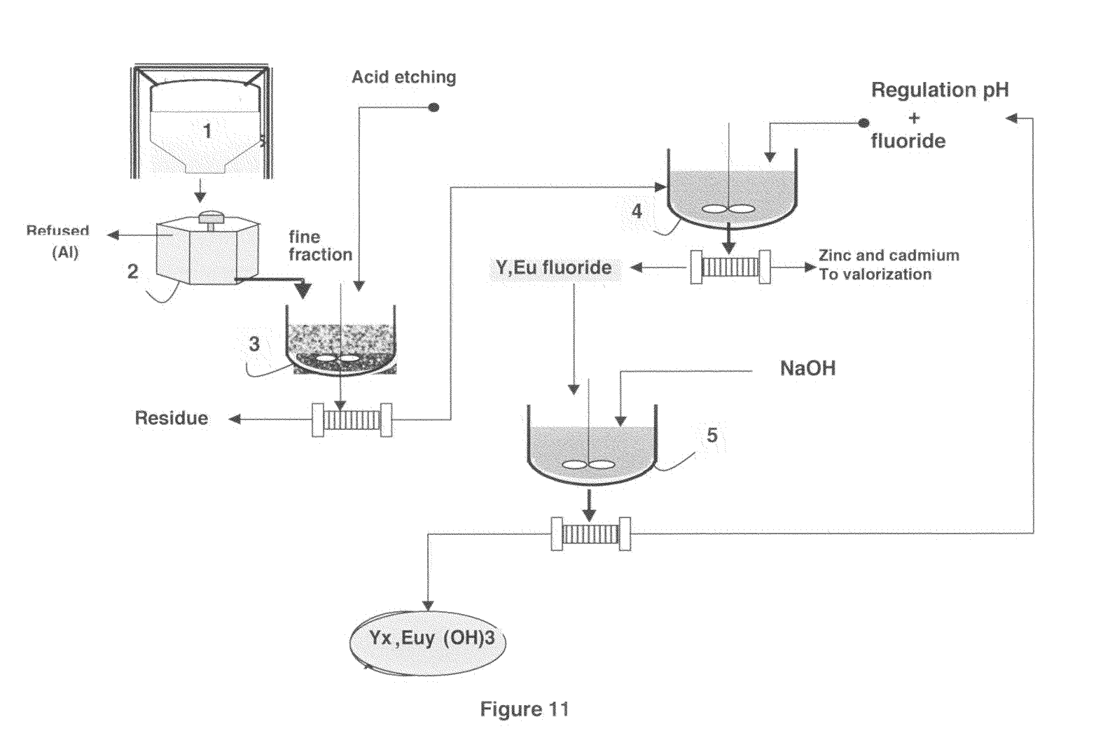

After the screening operation, the chemical process proper is implemented as represented in FIG. 11. This process comprises the following steps:

### 1—Etching Step

The powder resulting from the treatment described above (references 1 and 2 in FIG. 11) is dissolved with 2N sulphuric acid at a temperature fixed at 70° C. (reference 3 in FIG. 11). The concentration of acid can vary within a range comprised between 15% in weight and 35% in weight. But for reasons of trade-off between reaction speed and dilution, it is preferably fixed at a value comprised between 17% and 22% in weight. Filtration of the solution resulting from acid attack is performed to separate the liquor containing the metals from the insoluble residues.

### 2—Neutralization—Fluoridation Step

In this step (reference 4 in FIG. 11), the liquor is then neutralized to a pH comprised between 2.8 and 4.4 by means of soda, potash, lime or magnesia. The optimal neutralization value for good implementation of the subsequent operations has been found to be equal to 3.4.

Neutralization can advantageously be performed by means of soda or potash with a concentration comprised between 10% and 35% in weight. The neutralized solution is then mixed with an alkaline fluoride solution (for example potassium or sodium fluoride) heated at 50° C. and in a stoichiometric ratio equal to that of the Yttrium+Europium content increased by 10% weight. The precipitate formed is then separated and then washed with industrial water at a temperature comprised between 30° and 40° C. This washing water is then used in the first step of the process for preparing the 2N acid from concentrated acid.

### 3—Hydroxylation Step

The solid is then suspended in a soda solution at 30% (reference 5 in FIG. 11) and a whitish precipitate forms. After filtration, the slightly alkaline fluoride solution is re-used in the step represented by reference 2 in FIG. 11, whereas the solid is dried at 105° C.

### IV—Recycling the Glasses

The cathode ray tubes are composed of two types of glass:
a lead glass for the cone
a barium and sometimes strontium glass for the screen faceplate.

For a good valorization, the glasses have to be treated separately. To avoid pollution, in particular of the barium glass by the lead, melting is performed in an externally cooled inductive loop, thus forming a self-crucible. This self-crucible presents a large number of advantages, one of which is formation of a frozen layer of glass around the crucible, which avoids any use of refractory material and any pollution of the glasses.

To obtain a constant composition on output, the silica, barita and strontium carbonate contents are adjusted by making addition to the crucible. The high-frequency electric field lines cause turbulences in the molten bath which have the huge advantage of homogenizing the molten material. This enables uniform melting to be obtained, and consequently results on output in a glass of homogeneous composition with a total absence of unfused material.

1. A method for integral recycling of cathode ray tubes, enabling glasses composing said cathode ray tubes and the luminophores deposited on an internal surface of screens to be recycled by associating the following steps:
opening said cathode ray tubes by means of a laser source;
dry cleaning by means of at least a surface treatment agent; and
recycling of the luminophores by acid-base means in the presence of fluorides.

2. The method according to claim 1, wherein a surface treatment of the glasses is performed by means of at least a surface treatment agent selected from the group consisting of steel shot, sodium bicarbonate and calcite.

3. The method according to claim 1, wherein the step of recycling of the luminophores comprises a treatment of electroluminescent powders by means of sulphuric acid with a concentration comprised between 15% in weight and 35% in weight.

4. The method according to claim 1, wherein the step of recycling of the luminophores comprises a separation of yttrium and europium performed by means of a sodium or potassium fluoride at a pH comprised between 2.8 and 4.8.

5. The method according to claim 4, wherein the yttrium and the europium are extracted in hydroxide form by alkalisation by means of soda or potash with a concentration comprised between 10% and 35% in weight.

6. The method according to claim 5, wherein the extraction of the yttrium and the europium leads to regeneration of the alkaline fluoride which can be re-used in the first step of the process in separation of said yttrium and said europium.

7. The method according to claim 1, wherein separated glasses are melted by means of an induction crucible designed so as to constitute a self-crucible.

8. The method according to claim 7, wherein the composition of the glasses is adjusted by adding silica, barita and strontium carbonate directly in a molten bath into the crucible.
